(19) United States
(12) Patent Application Publication
(10) Pub. No.: US 2009/0266888 A1
(43) Pub. Date: Oct. 29, 2009

(54) METHOD FOR ORGANIZING AND INVENTORYING LIBRARY MATERIALS

(76) Inventor: Mary McCarthy, Seal Beach, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 12/107,920

(22) Filed: Apr. 23, 2008

(51) Int. Cl. G06F 19/00

(52) U.S. Cl. 235/385

(57) ABSTRACT

A method for simple organization, classification, and inventory of library materials includes the steps of naming the sections of the collection with a word descriptor, creating a color code whereby various styles of library materials are each assigned a unique color, creating an icon code whereby various genres of library materials are each assigned a unique icon, and providing a plurality of library material receptacles, each receptacle sized to store a portion of said library materials. Each receptacle is assigned a unique style and genre combination, and a label is attached onto the receptacle having a word descriptor, the unique style color code and genre icon combination prominently displayed. Each library material is then assigned a style and genre combination, and a label having the word descriptor, style color code and genre icon is attached onto said receptacle. Finally, each library material is placed in a receptacle where the label on the library material of a word descriptor, a color code and an icon matches a label on the receptacle of a word descriptor, a color code and an icon.

### BACKGROUND OF THE INVENTION

The present invention is directed to a method for organizing library materials, and more particularly but not exclusively children's books, for example in a school library, to promote instructional efficacy, rapid discovery, and inventory control in a cost effective and easy-to-understand manner.

Many elementary classroom book collections are comprised of stacks of books with little organization and control. As books are taken and replaced, the books progressively degenerate into disorganization until it is impossible to know which books are where. This shortcoming may be compounded by the fact that young children may find it difficult to re-shelve or replace books in traditional organizational methodologies such as by alphabetical order, content, or numerical shelving systems, leading to further chaos. The lack of any coherent organization system makes it difficult to locate specific books, and the teacher or librarian responsible for such collections is left without an effective method of inventorying the books that may be overstocked and those that should be supplemented. When it is time to restock or replace older books, the lack of any easy method for determining which types of books are in short supply can lead to overstocking books already adequate in numbers and a shortage of books in need of supplementing. Thus, there is a clear need for a method and system for organizing books that provides effective organization with simplicity that can be understood by young children, while providing quick inventory analysis.

U.S. Pat. No. 6,957,186 to Guheen et al. illustrates a system providing for the non-textual indicia coding of identifying various components of a system for building, managing, and support purposes. In this reference, an area of an existing network framework is first identified, and then the identified existing network framework including a plurality of components is presented with a pictorial representation. The redundancies and omissions of the components of the existing network are highlighted by indicia coding to complete the process. This system is unsuitable for the task of organizing children's books where small children are required to understand and implement the system, since Guheen is a sophisticated computer system involving networking, far beyond the comprehension of small children.

U.S. Pat. No. 6,716,032 to Reisz et al. describes a system and method for correlating a criteria for identifying the reading level of books to labeling leveled reading books through use of a graphical user interface. FIGS. 1 and 1A demonstrate that colors, numbers, and letters are assigned to particular grade levels, reading levels, and stages of development, respectively. Upon identifying the “grade level”, “DRA level”, “F&P level”, “Reading Recovery” and “Stages of Development” with respect to a particular book, the assigned colors, numbers and letters are then entered into the graphical user interface, then printed out onto labels for placement on the books. However, Reisz is not concerned with the organization and inventory of children's books but rather a way of coding the book's difficulty level.

U.S. Pat. No. 5,902,659 to Lewin illustrates a flexible labeling system for application to the spines of bound documents that are too thin to readily hold identification labels. The invention is comprised of a flexible plastic member with two hinges with adhesive strips and a centrally located stiffener on which adhesive labels may be affixed. FIG. 10 teaches that the labeling system can be applied to the exterior of an expandable file folder, allowing for easy viewing when placed on shelves. The Lewin reference teaches a particular labeling method, but does not concern the organization or inventory methods of the present invention.

U.S. Pat. No. 5,449,202 to Nalepka et al. describes a method and apparatus for the color coding and labeling of library books and shelved media systems. FIG. 1 illustrates that each label uses a number of horizontal bands, which consist of colors whereby each color is assigned a letter or number forming a part of the alpha-numeric library code. The system and method of Nalepka is ill-suited for children's books and in particular lacks the pictorial representations that are important to allow small children to understand and comply with the organizational rules of the present invention.

From the foregoing, it can be seen that the prior art lacks an effective, straight forward method and system for organizing children's books that allows instructional efficacy, organization, facile locating and retrieving, and inventory control while being easy to understand to the point that a child can implement the system and method.

### SUMMARY OF THE INVENTION

The present invention is a method for organizing library materials such as children's books using a series of bins or deposit receptacles with a word descriptor, iconographic images, colors, and other visual sorting modes that permit easy-to-understand sorting rules and provides a quick evaluation of the number of books for various classifications. Children can match labels on books having the word descriptor, color and icon coding with baskets having the same code to effectively organize the books or other library materials. For example, in a preferred embodiment a word descriptor, color code, and graphical icon are combined on a label located on the outside of a receptacle that dictates a sorting methodology by genre, literary style, language, and shelving location.

Other features and advantages of the invention will become apparent from the following detailed description, taken in conjunction with the accompanying drawings which illustrate, by way of example, the features of the invention

### BRIEF DESCRIPTION OF THE DRAWINGS

FIG. 1 is a flow chart of a series of steps to perform the method of organization;

FIG. 2 is a graphical depiction of a first preferred embodiment of a storage receptacle; and

FIG. 3 is a graphical representation of a key for the organizational method.

### DETAILED DESCRIPTION OF THE PREFERRED EMBODIMENTS

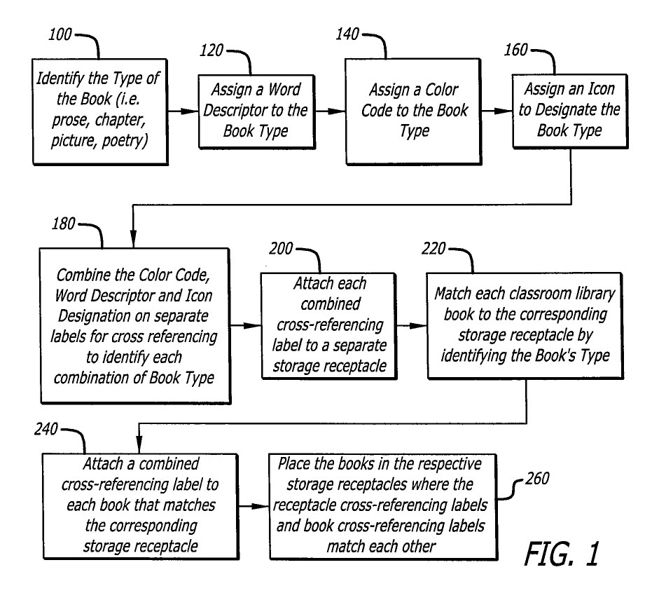

FIG. 1 is a flow chart illustrating a preferred method of the present invention for organizing and storing library materials, e.g. children's books. It is to be understood that while children's books are used as an example throughout the application, the system can be used for other library materials such as CDs, video tapes, DVDs, cassette tapes, game cartridges, electronic data storage media, and the like.

The first step 100 is to create a classification system for encompassing formats and/or genres of children's literature found in the collection of the library materials (hereafter referred to as “books” for convenience). These formats and/or genres may include fiction, nonfiction, chapter, picture, poetry, pop-up, and so forth. For simplicity the term “type” will be used to describe category of books that can include formats, genres, subject matter, or combinations thereof. Each book will be assigned one and only one classification type, which should be non-overlapping if possible to prevent ambiguities in the classification system. The classifications should be selected so as to encompass a number of different kinds of books, so that preferably there are a manageable number of classifications in the range of six to fifteen types total. Once the type of book is established, the next step 120 is to assign a word descriptor to each section of the classification system, such as a picture book, fantasy, or non-fiction. After each section is named, the next step 140 is to assign a color to each classification, such as red for picture books—realistic fiction, blue for chapter books—fantasy, green for nonfiction, purple for poetry books, etc., until each classification has an associated color. Colors are particularly easy for children to identify and appreciate, but the limited number of colors that can easily be distinguished by children also place a limitation on the number of classifications in the system. A catch-all category such as “miscellaneous” may be used to classify certain books that have no well defined classification. Although several different types may invariably overlap (fantasy and fairy tales, for example), the system accounts for this overlap as each book is assigned a single classification.

Once each book has been assigned a word descriptor and color code, the next step 160 is to assign an icon with each classification. The assignment of a pictorial icon associated with each type permits overlapping types to be easily identified in one category or another. That is, a child may not be able to distinguish between a fantasy book and a fairy book, but a child can differentiate a unicorn (an exemplary icon for fantasy) with a pixie (an exemplary icon for the fairy tale genre). The icon does not have to be selected so as to conjure up the corresponding genre in the mind of a child, but it is helpful if this is accomplished. Icons can be graphical representations of people, animals, objects, characters, symbols, or any pictorial illustration that can easily be identified with a genre of books. It may also be desirable to assign an icon to a particular language of a book, if there are many different languages being utilized. For example, there can be one icon for Spanish, another for French, and a third for German.

Step 180 represents the creation of labels to be used in connection with storage receptacles, where each label has a word descriptor, color code, and icon to identify a classification type for the storage location. There may be many combinations of word descriptors, colors and icons. For example, a realistic fiction picture book will share the same icon as a realistic fiction chapter book indicating the genre is the same. However, the color code will be different indicating the difference between picture book and chapter book. The labels can preferably be made of standard adhesive-backed printing labels that can be printed with a standard computer printer, although pre-fabricated labels of a more sturdy construction can also be used. When step 180 is complete and all labels are created, there should be enough word descriptor/color code/icon combinations to allow each book to be designated for a specific word descriptor/color code/icon combination.

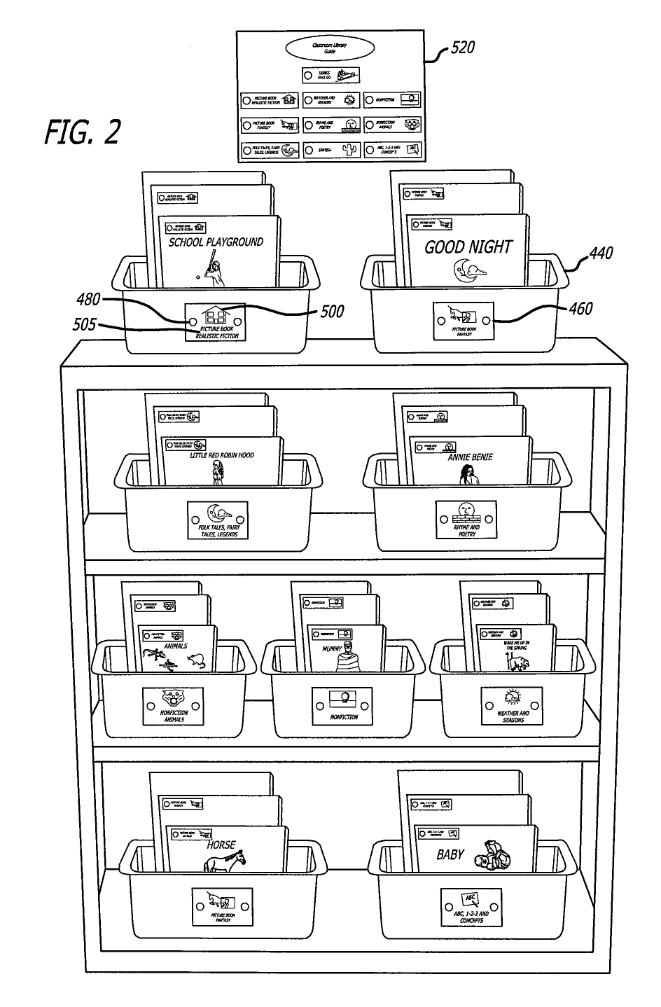

Step 200 corresponds to the attachment of each label to a storage receptacle such as an open-ended basket, bin, or box. An example of a reservoir with a label attached is shown in FIG. 2. The labels should be placed on the front of the receptacles so that they can easily identify the receptacles as being of a specific classification when the receptacles are on a shelf or table. It is preferable that the label be affixed in a substantially permanent nature, like adhesive, although removable attachment variants such as hook and loop attachments or slots on the receptacle for holding a card are also possibilities. Once the labels are attached to the appropriate receptacles, in step 220 each book is designated as belonging to a particular style and genre. This classification of each book allows the ordered organization of all books into their respective receptacles, where every book has one and only one style/genre pairing and thus each book can be assigned one word description, one color code, and one icon.

Once each book is classified in step 220, a corresponding label is created and attached in step 240 to each book having the appropriate word descriptor, color code and icon corresponding to the identified type. Each label should match one, and only one, word description, color code and icon designation on the receptacles such that each book has a proper storage location. Moreover, by viewing the label on the book and locating a matching label (word description, color code and icon) on the various receptacles, the ease with which the books may be organized can be carried out by a child. Step 260 carries out the organizing step, where a book is placed in the receptacle corresponding to the label on the book and the label on the receptacle.

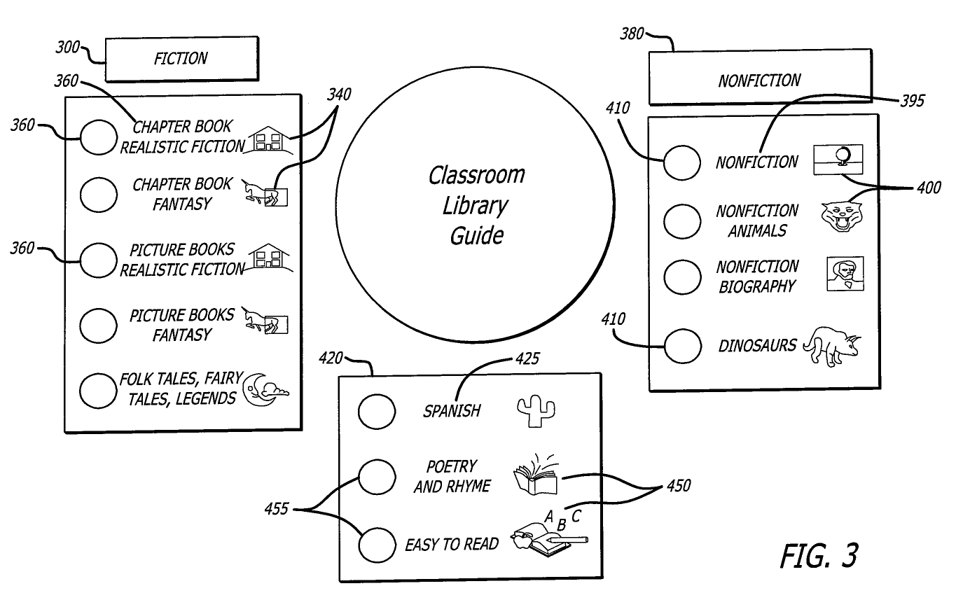

FIG. 3 illustrates a key or guide for the organization of the books as set forth above. It is preferable that the key is placed in proximity with the baskets or bins to aid in locating books and facilitating re-shelving books. The first group of classifications 300 include a heading called “Fiction,” 320 and includes styles of chapter books and picture books, and genres that include fantasy, realistic fiction, and folk tales, fairy tales, and legends. Each combination has a word description 330, an icon 340 and a color dot 360 that each cooperate to identify a classification. A second group of classifications 380 includes a heading called “Non-Fiction” that includes styles with word descriptors 395 such as non-fiction, animals, dinosaurs, and biographies. Clearly, there are many more possible book types than and those depicted are merely examples. Each type once again has an associated icon 400 that distinguishes the book from other genres, as well as a color designation 410 corresponding to the type. A third group 420 of classifications includes a language classification that includes word descriptors 425 such as Spanish, poetry, and “easy-to-read.” Each classification of group 420 has a different associated icon 450 and color code 455 that can be readily associated with a particular book subject.

FIG. 2 illustrates receptacles 440 that may be used in conjunction with a preferred embodiment of the method of the present invention. The basket 440 is large enough to hold books of various sizes, particularly over-sized books that are common with children's books, and is preferably stackable with other baskets for improved storage when not in use. The basket 440 includes a label 460 that has a word descriptor 505, color code in the form of a colored dot 480, and an icon 500 associated with a particular book type, in this case the word descriptor “picture book realistic fiction” 505, a yellow dot 480 and a house icon 500 corresponding to picture books and realistic fiction. The label is prominently affixed to the front of the basket so that it may be identified easily from the front. Although shown as a dot, the color code could be represented by another shape such as a simple geometric shape (squares, triangles, etc.) or figures such as a cat's paw or smiley face.

The method of the present invention would preferably use a plurality of baskets 440 such as that shown in FIG. 2, each with its own corresponding combination of word descriptors, color dots and icon labels to uniquely identify a specific type combination for a book. In an alternate embodiment, the baskets themselves may be of various colors to designate a particular reading level or location. For example, red baskets can represent second grade books and blue baskets represent third grade books, or red baskets belong on the west wall and blue baskets belong on the east wall. A display placard 520 can be mounted or hung by the receptacles that catalog each combination of word descriptor, color code, and icon among the receptacles and books in the collection.

The present method utilizes matching codes on books that correspond to a specific receptacle that allows for simple, quick, and easy-to-understand filing that can be implemented and used by and with small children. The system is also a convenient inventory method, since each basket can be quickly inspected to determine how many books are classified in each category. For example, the picture books basket(s) can be investigated to see how many books are picture books, and this can be compared to other classifications. Inventory is made much simpler and more efficient than organizing stacks of books each time the task of inventory is required. As more books are added to the collection, they are classified as of a specific type, a sticker is prepared and placed on the book corresponding to the appropriate receptacle, and the book is deposited in the receptacle. When a book is removed from the receptacle, and needs to be returned, a child can locate the word descriptor, color code, and icon on the book's sticker, and locate the receptacle having the same characteristics. The child then places the book in the receptacle. Misfiled books are easily identified, as such books will have a different sticker from all other books in the receptacle, and thus can be removed and re-filed quickly. Thus, the system is expandable, easy to teach and learn, cost effective, and adaptable for all size collections. The system also teaches students about the organization of books and library materials in an easy to understand way, enhancing the child's ability to use school libraries, public libraries and bookstores. Children may explore characteristics of various types of literature by comparing and contrasting books within and between classifications, and learn more about ways to classify objects. Teachers are able to use library materials more effectively as the system facilitates the selection of library materials for instructional purposes and guiding student's reading choices.

The foregoing description is intended to be illustrative of the various forms and variations that may exist within the framework of the present invention. For example, while specific combinations of word, color, and symbols are used to identify a type of library material, other combinations involving fewer or greater identifiers are possible and considered within the scope of the present invention. That is, a system could be utilized with a color and icon without a word descriptor, or a word descriptor and icon without a color code, etc. Furthermore, the system can include a level indicator such as a number or other symbol signifying a grade or reading level that further classifies the materials. One of ordinary skill in the art will readily appreciate various modifications and variations to the above-described embodiments, and the scope of the invention is intended to include all such variations and modifications.

I claim:

1. A method for simple organization, classification, and inventory of library materials comprising the steps of:
creating a color code whereby various types of library materials are each assigned a unique color;
creating an icon code whereby various types of library materials are each assigned a unique icon;
providing a plurality of library material receptacles, each receptacle sized to store a portion of said library materials;
assigning each receptacle a unique type, and attaching a label onto said receptacle having the unique type's unique color code and unique icon combination prominently displayed;
assigning each library material a unique type, and attaching a label onto said receptacle having the unique type's unique color code and unique icon;
placing each library material in a receptacle where the label on the library material of a color code and icon matches a label on the receptacle of a color code and icon.

2. The method of claim 1, further comprising the step of inventorying specific type library materials by visually inspecting the various receptacles and adjusting inventory based on said visual inspection.

3. The method of claim 1, further comprising the step of creating an icon code whereby various languages of library materials are each assigned a unique icon.

4. The method of claim 1, wherein said receptacle is open ended and stackable.

5. The method of claim 1, where each receptacle itself has a color designating a reading level for library materials in said receptacle.

6. The method of claim 1, where each receptacle has a color designating a specified location for the receptacle.

7. The method of claim 1 further comprising assigning a unique word descriptor to a unique type of library material, and assigning said unique word descriptor to said label on said library material and said label on said receptacle.

8. A method for simple organization, classification, and inventory of a collection of children's library books having multiple genres and styles of books within the collection, comprising the steps of:
determining a total number of types of children's library books in the collection;
creating a color code of colors where the code includes a number of colors matching the total number of types of children's library books in the collection, and assigning one color among the number of colors for each type of children's library books;
creating a pictorial icon code of pictorial icons where the pictorial icon code includes a number of pictorial icons matching the number of types of children's library books in the collection, and assigning one pictorial icon among the number of pictorial icons for each type of children's library books;
providing a plurality of children's library book baskets, each children's library book basket sized to hold a plurality of the children's library books;
assigning each children's library book basket a type, where each children's library book basket is assigned a unique combination of color code and pictorial icon;
attaching a physical label to said children's library book basket where the physical label displays a word descriptor, the assigned color code, and the assigned pictorial icon combination thereon;
determining for each children's library book in said collection a type;
attaching a physical label to said each children's library book where the physical label displays a word descriptor, the color assigned to the determined type and pictorial icon assigned to the determined type; and
placing each children's library book in a children's library book basket where the physical label on the children's library book matches the physical label on the children's library book basket.

9. A kit for organizing children's books comprising:
a plurality of open ended receptacles for retaining a plurality of children's books therein;
a plurality of receptacle decals each sized to be affixed to one of said plurality of receptacles, the receptacle decals displaying a word descriptor of the books retained in said receptacle, a color code corresponding to a type of book retained in said receptacle, and a graphical icon corresponding to a type of the books retained in said receptacle;
a plurality of book decals to be affixed to said children's books, each said book decal including a word descriptor corresponding to the type of book to which the book decal is attached, a color code associated with the type of the book to which the book decal is attached, and a graphical icon associated with the type of said book to which the book decal is attached; and
a display placard identifying a each combination of word descriptor, color code, and icon assigned to a book and a receptacle.
